(19) United States
(12) Patent Application Publication
(10) Pub. No.: US 2012/0117809 A1
(43) Pub. Date: May 17, 2012

(54) CHAINSAW ARRANGEMENT

(75) Inventor: Pär Martinsson, Jonkoping (SE)

(73) Assignee: HUSQVARNA AB, HUSKVARNA (SE)

(21) Appl. No.: 13/140,796

(22) PCT Filed: Dec. 18, 2008
(86) PCT No.: PCT/SE2008/051503

§ 371 Date: Sep. 8, 2011

(51) Int. Cl. B27B 17/08; B25F 5/02

(52) U.S. Cl. 30/381

(57) ABSTRACT

A chainsaw (1) comprises an internal combustion engine (3) having a cylinder (4) with a piston (5) connected to a crankshaft (6). The piston (5) has an upper surface at a distance D from the central axis of the crankshaft (6) measured along the longitudinal axis defined by the cylinder (4), when the piston (5) is in its top dead centre. The chainsaw (1) is further provided with a front handle (7), which central axis is disposed at a distance B from the central axis of the crank shaft (6) along an axis substantially perpendicular to a horizontal plane (13), the horizontal plane (13) being defined as the plane on which the chainsaw (1) may rest in an upright position when not operated. The chainsaw (1) also includes a throttle lever (9), which rear end is disposed at a distance C from the central axis of the crankshaft (6) along an axis substantially parallel to the horizontal plane (13). The cylinder (4) is inclined backwards, such that the angle between the longitudinal axis defined by the cylinder (4) and an axis perpendicular to the horizontal plane (13) is between 5 and 45° , and the chainsaw (1) further having a basic design such that the relation B/D is less than or equal to 1.7, so as to provide a low front handle (7).

### TECHNICAL FIELD

The present invention relates to a chainsaw including an internal combustion engine having a cylinder with a piston connected to a crankshaft, which piston has an upper surface at a distance D from the central axis of the crankshaft measured along the longitudinal axis defined by the cylinder, when the piston is in its top dead centre. Also, the invention relates to a chainsaw with a front handle, which central axis is disposed at a distance B from the central axis of the crank shaft along a perpendicular to a horizontal plane, the horizontal plane being defined as a plane on which the chainsaw may rest in an upright position when not operated. Further, the chainsaw includes a throttle lever, which rear end is disposed at a distance C from the central axis of the crankshaft along an axis substantially parallel to the horizontal plane.

### BACKGROUND ART

An object when designing a conventional chainsaw, particularly one powered by an internal combustion engine, has generally been to minimize the length of the chainsaw body along the longitudinal axis of the chainsaw. Typically, the distance between the crank shaft and the front end of the chainsaw body is rather small. An advantage of this design is that a smaller portion of the guide bar is enclosed within the chainsaw body. This permits a shorter guide bar but still retaining the reach of the chainsaw.

However, the rather short length of the chainsaw body often implies a large height, especially for the front portion of the chainsaw body. This further means that the front handle is located at a large distance from, i.e. above, the centre of mass of the chainsaw, which centre is typically disposed a short distance behind the crank shaft of the internal combustion engine. The front handle being far from the centre of mass implies that the front handle is far from the axis about which the chainsaw is tilted when the saw bar is tilted, which axis is hereinafter referred to as the axis of rotation and is preferably substantially parallel to a longitudinal axis of the chainsaw. As the saw bar is often quickly tilted when cutting branches, the long distance between the front handle and the axis of rotation has proved to be a major drawback. With such configuration much effort is required for operating the chainsaw and the operator easily gets exhausted. The long distance also implies that the hand holding the front handle is moved a long distance when the chainsaw is tilted about said axis and the operator then experiences that the wrist is extensively bent in relation to the hand, which is an ergonomic disadvantage.

Moreover, the position of the front handle is regulated by law, i.e. the front handle must be separated at least 35 mm from the chainsaw body. Conventionally, this distance is closer to 45 mm.

### SUMMARY OF THE INVENTION

A first object of the invention is to provide a chainsaw that requires less effort by the operator and has an ergonomic advantage.

This object is achieved by a chainsaw of the type mentioned in the first paragraph, wherein the cylinder is inclined backwards, such that the angle, between the longitudinal axis defined by the cylinder and a perpendicular to the horizontal plane is between 5 and 45°, and the chainsaw further being designed such that the relation B/D is less than 1.7, so that the distance between the front handle and the axis about which the chainsaw is tilted when operated may be decreased. The smaller radius between the axis of rotation and the front handle implies that less moment is needed for tilting the chainsaw about the axis of rotation. This has proved to be less exhausting to the operator and to make his/her work more efficient. The smaller radius also enables the front handle and the hand holding it to move a shorter distance when the chainsaw is turned about said axis. This e.g. allows the wrist not to be very much bent in relation to the hand, which is an ergonomic advantage.

A second object of the invention is to provide also a further ergonomic advantage and to improve the control of the chainsaw when operating.

This object is achieved by the chainsaw as described above by also increasing the distance between the front handle and the rear end of the throttle lever, such that the relation C/B is greater than 1.10. Thereby, the positions of the hands of the operator are more separated when operating the chainsaw and more correspond to the positions of the hands when relaxing the arms by the sides of the body. This has proved to be an ergonomic advantage as well as providing a better control of the chainsaw.

Other features of the invention are specified in the appended dependent claims, and what is achieved by these features will be disclosed below with support of the appended drawings.

### BRIEF DESCRIPTION OF THE DRAWINGS

In the following, the invention will be described in more detail with reference to preferred embodiments and appended drawings.

FIG. 1 is a cross-sectional view of a chainsaw 1 according to a preferred embodiment of the invention.

FIG. 2 is a cross-sectional view of a chainsaw 1 according to another preferred embodiment of the invention.

FIG. 3 is a cross-sectional view of the muffler 14 in the chainsaw of FIG. 2.

### DETAILED DESCRIPTION OF THE PREFERRED EMBODIMENTS

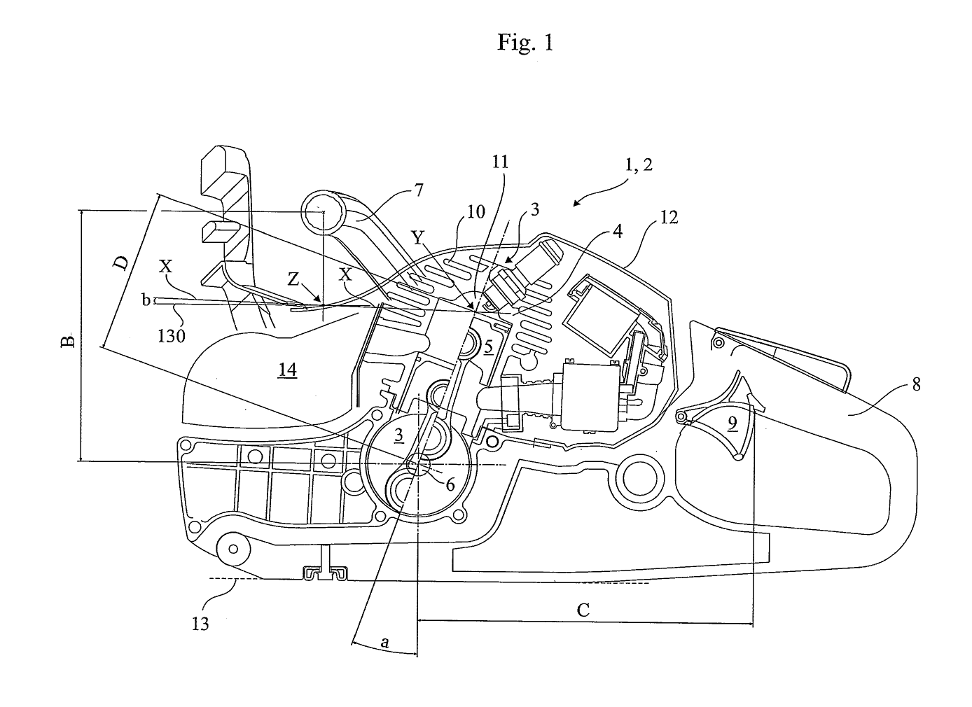

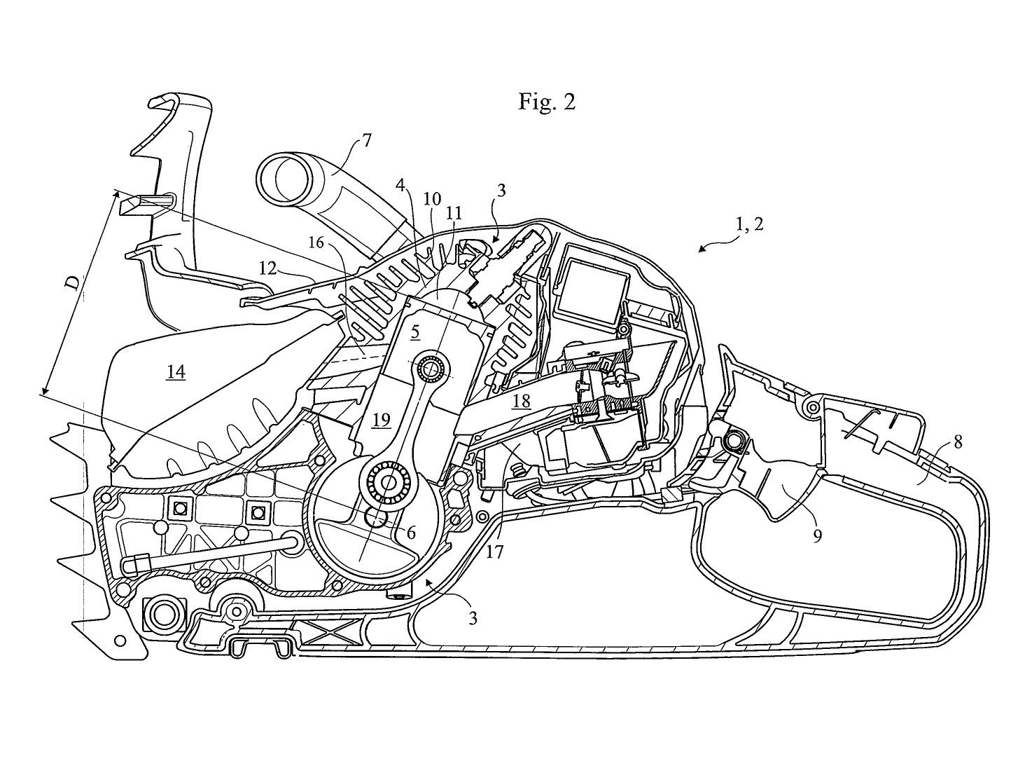

The chainsaws 1 shown in FIGS. 1 and 2 each has an internal combustion engine 3 with a cylinder 4, in which a piston 5 connected to a crank shaft 6 is reciprocatingly guided. The cylinder 4 is inclined backwards by an angle a in relation to a perpendicular to a horizontal plane 13 in order to enable a low front of the chainsaw body 2 and in turn enabling the front handle 7 to be closer to the centre of mass (not shown) of the chainsaw 1, or more specifically, to be closer to the axis of rotation (not shown) as defined earlier. The horizontal plane 13 is defined as the plane on which the chainsaw 1 may rest in an upright position when not operated, preferably the plane that is kept in contact with a flat bottom surface of the chainsaw 1. In the configuration as shown in FIG. 1 the angle a is approximately 20°, but it may be 5-45° (e.g. 9°, 12°, 15°, 18°, 22°, 25°, 30°, 35° or)40° and still enabling a beneficial relation between the distances B and D, where D is the distance between the centre of the crank shaft 6 and the top surface of the piston 5 when the piston 5 is in its top dead centre, which top dead centre state is shown on the right side of the central axis of the cylinder 4. B is the distance between a central axis of the front handle 7 and the central axis of the crank shaft 6 along a perpendicular to the horizontal plane 13. The relation B/D in FIG. 1 is 1.52 but may be less than or equal to 1.7, e.g. 1.64 or 1.56, and still providing the advantages of the chainsaw 1 of the present invention, such as requiring less effort for the operator and being ergonomically favourable, which advantages are described in more detail in earlier sections.

C is the distance between the central axis of the crank shaft 6 and the rear end of the throttle lever 9 along an axis parallel to the horizontal plane 13. The throttle lever 9 is engaged by the hand of the operator holding the back handle 8, and usually by the forefinger. The relation C/B is preferably greater than or equal to 1.10 and for the embodiment in FIG. 1, C/B equals 1.30. Studies have shown that a value greater or equal to 1.10, such as 1.12, 1.15, 1.20, 1.25, 1.40 or greater, probably provide an ergonomic advantage and a sense of stability and control to the operator, especially in combination with a configuration where B/D is less than or equal to 1.7 as described above. Increasing the relation C/B is also a convenient way of keeping a beneficial value of the relation B/D and still having enough space for arranging the parts within the chainsaw housing 12.

b is an angle between a line X and an axis 130 parallel to the horizontal plane 13, the line X being determined by the two points Z and Y, where Z corresponds to the point where an axis, originating substantially in the middle of the front handle 7 and being substantially perpendicular to the horizontal plane 13, meets the top of the chainsaw 1, preferably the chainsaw housing 12, and Y corresponds to a point in the centre of the top surface of the piston 5 when the piston 5 is in its top dead centre, and said angle b is less than 20° and preferably less than 18° but greater than 0°, such as 15°, 12°, 10°, 8°, 6°, 2° or smaller. In the embodiment in FIG. 1, the angle b is approximately 5°.

It has proved beneficial if at least one cooling fin 10 of the cylinder 4 is above the point Z, which means that the distance between the highest point of a cooling fin 10 and the horizontal plane 13 is greater than the distance between the point Z and the horizontal plane 13. Also, it is advantageous if at least a part of the combustion chamber 11 or a part of the piston 5 in its top dead centre is above the point Z in relation to the horizontal plane 13.

The configuration of parts within the chainsaw housing 12 has been adapted to the new form of the chainsaw body 2 to enable the relations as defined above. E.g., the cooling fins 10 of the cylinder 4 have been modified to adapt to the new basic design, whereby the cylinder 4 has a more asymmetrical shape than conventional cylinders. Also, the muffler 14 is generally deviating from a conventional square shape and it is preferably flat and elongated in the longitudinal direction of the chainsaw 1 as is shown in FIG. 1-2.

Preferably, the present invention is applied to a chainsaw 1 with a crankcase scavenged two-stroke engine 3 which has a cylinder 4 being connected to at least one air duct 17 for additional air as is shown in FIG. 2. The air duct 17 supplies at least one transfer channel (not shown) connecting a combustion chamber 11 and a crank room 19 with fresh air through at least one recess (not shown) in the piston 5. The at least one recess, the air duct/s 17 and the transfer channel/s together form a piston ported valve which is open when the piston 5 is in and/or near its top dead centre position. The fresh air is drawn into the transfer channel/s using a decrease of pressure in the crank room 19 for said position/s of the piston 5. Consequently, the transfer channel/s will be occupied with a buffer of fresh air when the piston 5 is on its way down in the exhaust state of the engine 3. Therefore, before the combustion chamber 11 is supplied with a mixture of fuel and air through said transfer channel/s an amount of fresh air will blow into the combustion chamber 11 as the pressure in the crank room 19 increases and the fresh air will then be expelled through the exhaust duct 16. The buffer of fresh air in the transfer channel/s allows a very small amount of unburnt fuel to leave the engine 3, which is of course advantageous in terms of exhaust emissions. The air duct 17 for additional air in FIG. 2 is partly disposed below the mixture duct 18 for supplying the crank room 19 with a mixture of fuel and air, but can of course be configured differently.

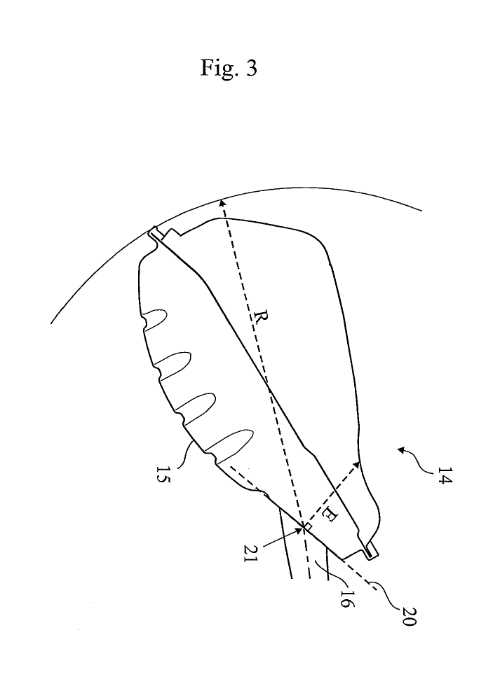

FIG. 3 is a cross-sectional view of the muffler 14 in FIG. 2 where the distance R is a radius of a circle which centre coincides with the centre point 21 of the exhaust duct interior where an end of the exhaust duct 16 is connected to a port of the muffler 14. This point will hereinafter be referred to as the reference point 21. The distance R is defined as the greatest distance in any direction that the muffler 14 extends from said reference point 21. The radius may coincide with a longitudinal plane of the muffler 14 as in FIG. 3 or be inclined in relation to said longitudinal plane. A connecting plane 20 is defined by the plane where the exhaust duct 16 meets the muffler 14. The connecting plane 20 may be perpendicular to a longitudinal plane of the muffler 14 as in FIG. 3 or be inclined differently in relation to said longitudinal plane. The distance E is the distance from the reference point 21 to the exterior of the muffler 14 along a perpendicular to the connecting plane 20. The relation E/R in FIG. 3 is approximately 0.3 but the shape of the muffler 14 may of course be configured differently with E/R corresponding to values 0.2, 0.4, 0.5, 0.6, 0.7 or 0.8 and still allowing the benefits of a low front of the chainsaw 1.

Preferably, the exhaust inlet side 15 of the muffler 14 has a substantially convex shape. Alternatively, the muffler 14 is generally pear shaped.

1-16. (canceled)

17. A chainsaw comprising:
an internal combustion engine having a cylinder with a piston connected to a crankshaft;
said piston having an upper surface at a distance D from the central axis of the crankshaft measured along the longitudinal axis defined by the cylinder, when the piston is in its top dead centre;
a front handle, which central axis is disposed at a distance B from the central axis of the crank shaft along an axis substantially perpendicular to a horizontal plane, the horizontal plane being defined as the plane on which the chainsaw may rest in an upright position when not operated;
a throttle lever, which rear end is disposed at a distance from the central axis of the crankshaft along an axis substantially parallel to the horizontal plane;
the cylinder is inclined backwards, such that the angle, hereinafter denoted by a, between the longitudinal axis defined by the cylinder and an axis perpendicular to the horizontal plane is between 5 and 45°, and the chainsaw further having a basic design such that the relation B/D is less than or equal to 1.7, so as to provide a low front handle.

18. The chainsaw according to claim 17 wherein the angle a is between 9° and 35°.

19. The chainsaw according to claim 18 wherein the angle a is between 15° and 25°.

20. The chainsaw according to claim 17 wherein the relation B/D is less than 1.64 and preferably less than 1.56.

21. The chainsaw according to claim 17 wherein a relation C/B is greater than 1.1 and preferably greater than 1.2.

22. The chainsaw according to claim 17 wherein b is an angle between a line X and the horizontal plane, the line X being determined by the two points Z and Y, where Z corresponds to the point where an axis, originating substantially in the middle of the front handle and being substantially perpendicular to the horizontal plane, meets the top of the chainsaw, preferably on top of the chainsaw housing, and Y corresponds to a point in the centre of the top surface of the piston when the piston is in its top dead centre; characterized in that said angle b is less than 20° but more than 0°.

23. The chainsaw according to claim 22 wherein the angle b is less than 12°.

24. The chainsaw according to claim 23 wherein the angle b is less than 8°.

25. The chainsaw according to claim 22 wherein the cylinder is provided with cooling fins and at least one cooling fin and preferably a number of cooling fins are disposed above the point Z in relation to the horizontal plane.

26. The chainsaw according to claim 22 wherein the cylinder is provided with a combustion chamber and at least a part of the combustion chamber is above the point Z in relation to the horizontal plane.

27. The chainsaw according to claim 22 wherein at least a part of the piston is above the point Z in relation to the horizontal plane when the piston is in its top dead centre.

28. The chainsaw according to claim 17 wherein the internal combustion engine is provided with a combustion chamber and a part of the cylinder is arranged as an exhaust duct for leading exhaust gases from said combustion chamber to a muffler, wherein an end of the exhaust duct is connected to a port of the muffler and R is a radius of a circle which centre coincides with the centre point of the exhaust duct interior where the exhaust duct is connected to the muffler port, which centre point of the exhaust duct will hereinafter be referred to as the reference point;
R is further defined as the greatest distance in any direction that the muffler extends from said reference point; a connecting plane is defined as the plane where the exhaust duct meets the muffler and E is the distance from the reference point to the exterior of the muffler parallel to a perpendicular to said connecting plane; characterized in that the relation E/R is less than 0.8 and preferably less than 0.7.

29. The chainsaw according to claim 28 wherein E/R is less than 0.6.

30. The chainsaw according to claim 29 wherein E/R is less than 0.4.

31. The chainsaw according to claim 28 wherein an exhaust inlet side of the muffler has a generally convex shape.

32. The chainsaw according to claim 17 wherein the internal combustion engine is a crankcase scavenged two-stroke engine which cylinder has at least one transfer channel and additional air is supplied from an air duct and preferably via a piston ported valve to the at least one transfer channel.
